(19) United States
(12) Patent Application Publication
(10) Pub. No.: US 2012/0237197 A1
(43) Pub. Date: Sep. 20, 2012

(54) IMAGING APPARATUS

(75) Inventor: Toshihiko IWATANI, Hyogo (JP)

(73) Assignee: Panasonic Corporation, Osaka (JP)

(21) Appl. No.: 13/361,962

(22) Filed: Jan. 31, 2012

(30) Foreign Application Priority Data
Mar. 17, 2011 (JP) 2011-059102

(51) Int. Cl. G03B 17/02

(52) U.S. Cl. 396/535

(57) ABSTRACT

An imaging apparatus is provided that includes a hot shoe and a control unit. The hot shoe has a plurality of terminals configured to establish an electrical connection with an external flash device. The control unit is configured to communicate with the external flash device using at least one of the plurality of terminals when the external flash device is connected to the hot shoe. The control unit is further configured to determine the type of external flash device connected to the hot shoe so as to cause each of the plurality of terminals to function in accordance with the type of external flash device connected to the hot shoe.

### CROSS-REFERENCE TO RELATED APPLICATION

This application claims priority to Japanese Patent Application No 2011-059102 filed on Mar. 17, 2011, the entire disclosure of which is hereby incorporated herein by reference.

### BACKGROUND

1. Technical Field

The present technology relates to an imaging apparatus including a hot shoe, and more particularly, to an imaging apparatus including a hot shoe via which an external device, such as a flash device, can be connected to and used by the imaging apparatus.

2. Background Information

As is well known, hot shoes, which are accessory shoes used to mount an external device on a photographing apparatus, additionally include a contact terminal for transmitting information about the flash start timing to a flash device. Since that original design, the hot shoes have evolved through adding more communication terminals besides the contact terminal for transmitting the flash start timing to a flash device (see, for example, Japanese Unexamined Patent Publication No. H10-048707). The domestic standardization defines the hot shoes as a holder via which an accessory can be mounted onto a camera. The hot shoes are now categorized as (1) shoes having a contact for a synchronizer and (2) shoes without having a synchronizer contact. Although the position of the synchronizer contact of the hot shoe and the shape of the holding part are partially standardized, the positions and the shapes of other signal terminals of the hot shoe, except the contact terminal for transmitting the flash start timing to the flash device, can vary between different manufactures. The photographing apparatus may need an adapter on its hot shoe to connect to a flash device manufactured by a different manufacturer.

An accessory shoe can be used to mount various accessories (external devices) including a finder, an exposure meter, a level meter, a range finder, and an autofocus (AF) assist lamp. The accessory shoe is designed to withstand impact applied to it via an accessory mounted on the shoe. The accessory shoe is a machine part that is expected to have still more applications in the future.

For ease of explanation, a flash device that independently includes an internal power supply and can independently operate, or for example can independently adjust emission light or charge in a controlled manner, without being supplied with power from an imaging apparatus will be hereafter referred to as a “general-purpose external flash device”. Conversely, an electric accessory that can be mounted on a hot shoe of an imaging apparatus and that operates using power supplied from the imaging apparatus is hereafter referred to as a “specific accessory device”.

In recent years, movie recorders, which have been mainly used to record moving images, and compact imaging apparatuses including a built-in lens also tend to include hot shoes. For ease of explanation, an image receiving and recording system that is capable of capturing still images and that includes a hot shoe is hereafter broadly referred to as an “imaging apparatus including a hot shoe”.

A technology known in the art associated with an imaging apparatus including a hot shoe will now be described with reference to FIGS. 1 to 3.

FIG. 1 is a perspective view of a bottom part of a general-purpose external flash device 910.

FIG. 2 is a perspective view of an upper part of a camera (an imaging apparatus) 920 including a hot shoe.

FIG. 3 is a block diagram schematically showing connection between the general-purpose external flash device 910 and the camera (imaging apparatus) 920.

As shown in FIG. 3, the general-purpose external flash device 910 includes a removable battery V2, which functions as an internal power supply of the flash device.

A plate-like shoe foot 2, which is arranged on a bottom 1 of the general-purpose external flash device 910, is mounted on a rail-shaped accessory holder 111, which is arranged on a camera top 100a of the imaging apparatus 920.

A locking pin 4, and a screw-type locking ring 3 arranged on the shoe foot 2, which are both included in the general-purpose external flash device 910, are used to securely connect the general-purpose external flash device 910 to the imaging apparatus 920. More specifically, as the locking ring 3 is turned in a direction in which the locking ring 3 presses the accessory holder 111 of the imaging apparatus 920, the locking pin 4 projects toward the bottom of the flash device and is fit into a locking pin hole 112 formed in the camera top 100a. This fastens the general-purpose external flash device 910 and the imaging apparatus 920 together.

When the shoe foot 2 is mounted until it reaches a predetermined position, hot-shoe-connection terminals (5 to 8) of the general-purpose external flash device 910 and shoe terminals (113 to 116) of the imaging apparatus 920 are electrically connected to each other. This causes contact between the same signals corresponding to the connected pairs of the hot-shoe-connection terminals (5 to 8) of the general-purpose external flash device 910 and the shoe terminals (113 to 116) of the imaging apparatus 920, and enables communication between the general-purpose external flash device 910 and the imaging apparatus 920.

For ease of explanation, the communication connection terminals (5 to 8) of the general-purpose external flash device 910 are hereafter collectively referred to as “hot-shoe-connection terminals”, whereas the communication terminals (113 to 116) of the hot shoes are hereafter collectively referred to as “shoe terminals”.

In the example shown in FIGS. 1 to 3, the trigger terminal (the synchronization connection terminal) 5 and the synchronization terminal 113 come in contact with each other to achieve electrical connection between them. Moreover, the TTL control signal connection terminal 7 and the TTL control signal terminal 114 come in contact with each other to achieve electrical connection between them, the transmission connection terminal 6 and the transmission terminal 116, and also the reception connection terminal 8 and the reception terminal 115 come in contact with each other and achieve electrical connection between them.

Information about the flash start timing of the general-purpose external flash device 910 is transmitted from a camera control unit 921 included in the imaging apparatus 920 to a flash device control circuit 911 included in the general-purpose external flash device 910 via the synchronization terminal 113 of the imaging apparatus 920 and the trigger terminal 5 of the general-purpose external flash device 910. Other information, such as information about emission light adjustment, is transmitted and received between the general-purpose external flash device 910 and the imaging apparatus 920 using the other communication terminals (6 to 8, 114 to 116) before the flashing operation is performed. Such communication is known in the art and will not be described in detail.

As described above, the general-purpose external flash device 910 is connected to the hot shoe of the imaging apparatus 920, and then the general-purpose external flash device 910 is controlled by the imaging apparatus 920. This enables the imaging apparatus 920 to perform, for example, flash photographing using the general-purpose external flash device 910.

### SUMMARY

However, the above conventional technology requires the general-purpose external flash device 910 to independently include a power supply. In this case, the general-purpose external flash device 910, which is to be connected to the imaging apparatus 920 via the hot shoe, cannot achieve the compact design.

As shown in FIG. 3, the functional unit for controlling the charge circuit of the general-purpose external flash device 910 (the flash device control circuit 911) is arranged external to the imaging apparatus 920 (in other words, it is arranged inside the general-purpose external flash device 910). In this case, the imaging apparatus 920 cannot directly perform the emission light adjustment.

In contrast, conventional imaging apparatuses including a built-in flash device can directly perform the emission light adjustment.

A conventional imaging apparatus including a built-in flash device will now be described with reference to FIGS. 4 and 5.

Conventional Built-in Flash Device Operation

FIG. 4 schematically shows the structure of a conventional imaging apparatus 930 including a built-in flash device (hereafter called, a built-in flash imaging apparatus). FIG. 5 schematically shows the structure of another conventional built-in flash imaging apparatus 940.

As shown in FIG. 4, the built-in flash imaging apparatus 930 includes a flash device charge control circuit 932 that exclusively executes voltage feedback control for charging the built-in flash device. In this imaging apparatus 930, a charge control signal generated by a camera control unit 931 only indicates whether the flash device charging is permitted or prohibited. In response to the charge control signal, a flash device charge control circuit 932 executes control for charging the flash device, and transmits, to the camera control unit 931, a state signal indicating whether the charging has been completed or has yet to be completed.

To adjust the emission light, the camera control unit 931 can directly drive or stop a switch (formed by, for example, an insulated gate bipolar transistor (IGBT)) for switching a light-emitting element included in a light-emitting unit 934. In this case, the built-in flash imaging apparatus 930 includes no component that would cause major delay in performing the emission light adjustment.

The built-in flash imaging apparatus 940 shown in FIG. 5 includes a camera control unit 941 that directly performs the flash device charging.

The camera control unit 941 directly transmits charging pulses for causing a voltage raising operation to a flash device charge circuit 942, while directly monitoring the charge voltage value of a main capacitor (not shown) forming the flash device included in the flash device charge circuit 942.

To adjust the emission light, the camera control unit 941 can also directly drive and stop a switch for switching on and off the light emitting element included in a light-emitting unit 943. Thus, the built-in flash imaging apparatus 940 can execute the emission light adjustment (light emission control) without any delay.

As described above, the built-in flash imaging apparatus can directly perform the emission light adjustment. However, the built-in flash imaging apparatus can lack versatility because its functions are limited by the circuits and the like incorporated in the apparatus.

An external flash device and a flash device built in a camera apparatus differ from each other in the following:

(1) whether the flash device can be driven independently using its internal power supply, and

(2) whether the flash device allows the camera apparatus (the imaging apparatus) to perform the emission light adjustment by directly driving the switch for switching on and off the current flowing through the light-emitting element.

To adjust the light emission time, some old-type flash devices (old flash devices) may charge their trigger terminal (connection terminal for a synchronizer) with a high potential. To use such old-type flash devices, conventional camera apparatuses also include a high-voltage switch (formed by, for example, a thyristor) arranged at their trigger terminal. Many recent camera apparatuses (imaging apparatuses) still include such a high-voltage switch device, which would significantly delay the light emission signals. The delay of the light emission signals is particularly large when the camera is off. In that state, the camera (the imaging apparatus) cannot directly control the light emission time (or cannot directly adjust the emission light).

In view of the problem discussed herein above, one object of the present technology disclosed herein is to provide an imaging apparatus that includes a hot shoe and a control unit. The hot shoe has a plurality of terminals configured to establish an electrical connection with an external flash device. The control unit is configured to communicate with the external flash device using at least one of the plurality of terminals when the external flash device is connected to the hot shoe. The control unit is further configured to determine the type of external flash device connected to the hot shoe so as to cause each of the plurality of terminals to function in accordance with the type of external flash device connected to the hot shoe.

Another object of the present technology disclosed herein is to provide an imaging apparatus that includes a hot shoe, a control unit, and a power supply unit. The hot shoe has a plurality of terminals configured to establish an electrical connection with an external flash device. The control unit is configured to communicate with the external flash device via at least one of the plurality of terminals when the external flash device is connected to the hot shoe. The control unit is further configured to determine the type of external flash device connected to the hot shoe and whether power is to be supplied to the external flash device via at least one of the plurality of terminals based on the type of external flash device connected to the hot shoe. The power supply unit is configured to supply power to the external flash device via at least one of the plurality of terminals when the control unit determines that power is to be supplied to the external flash device.

These and other objects, features, aspects and advantages of the present invention will become apparent to those skilled in the art from the following detailed description, which, taken in conjunction with the annexed drawings, discloses example embodiments of the present invention.

### BRIEF DESCRIPTION OF THE DRAWINGS

Referring now to the attached drawings which form a part of this original disclosure:

FIG. 1 is a perspective view partially showing a flash device used in conventional practice;

FIG. 2 is a perspective view partially showing a camera apparatus used in conventional practice;

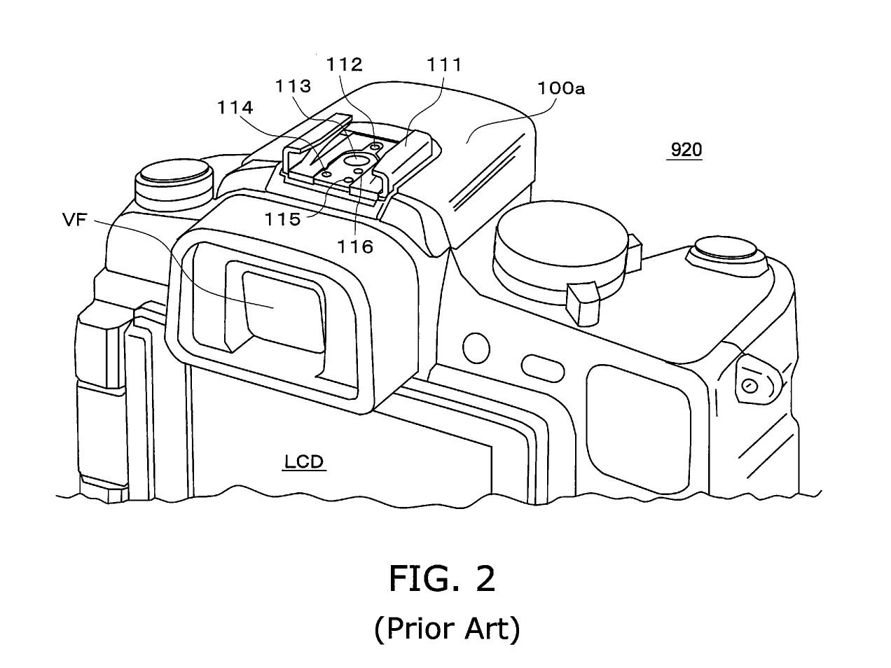

FIG. 3 is a block diagram showing an example of connection between the external flash device and the camera apparatus according to conventional practice;

FIG. 4 is a block diagram showing a conventional built-in flash device;

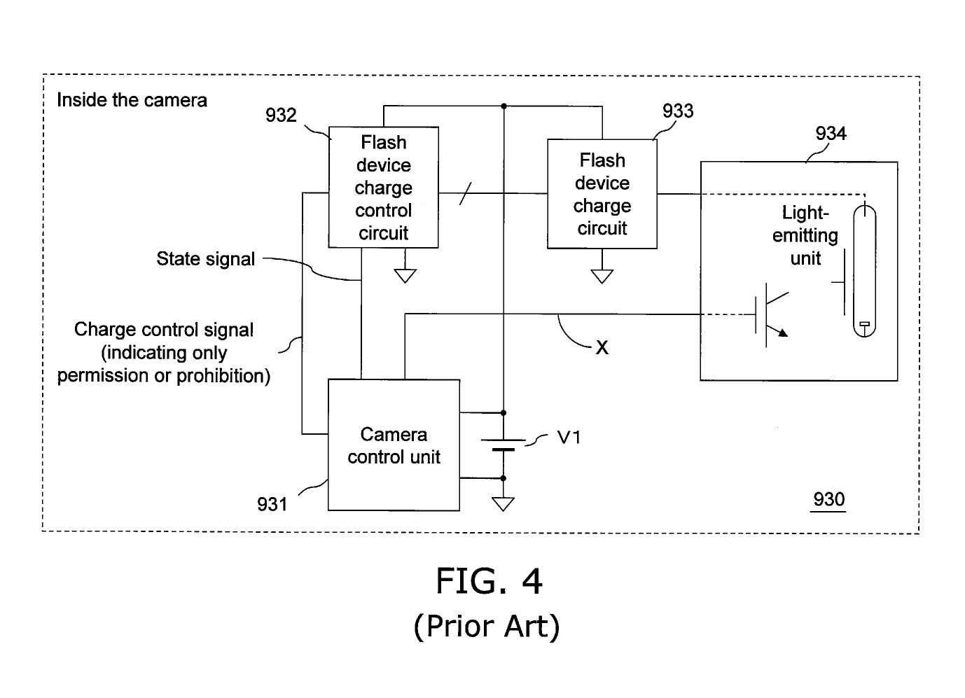

FIG. 5 is a block diagram showing another conventional built-in flash device;

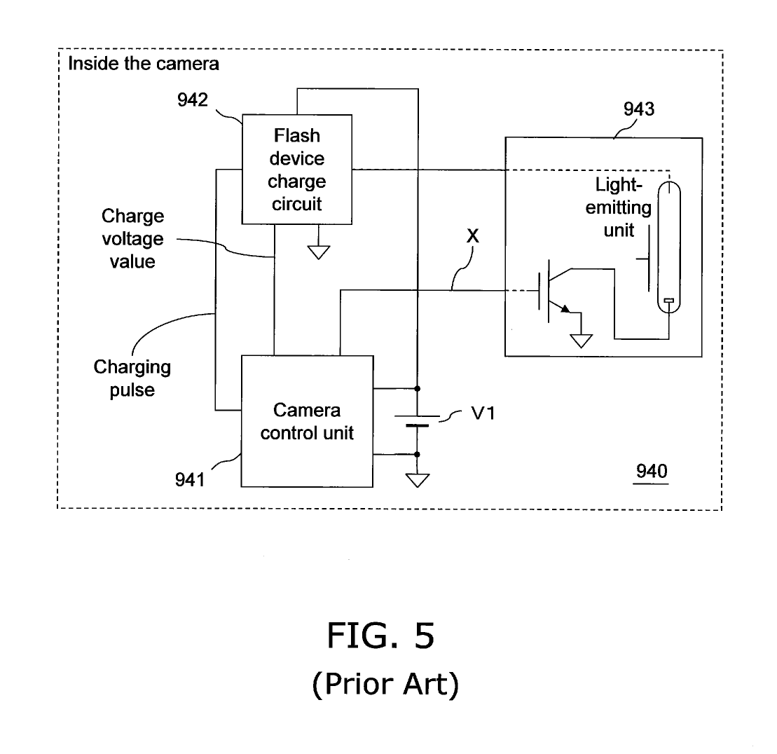

FIG. 6 is a block diagram showing connection according to a first embodiment;

FIG. 7 is a flowchart showing an operation according to the first embodiment;

FIG. 8A is a block diagram showing connection in the first embodiment;

FIG. 8B shows a circuit configuration of an imaging apparatus 1000 according to the first embodiment and a specific accessory device;

FIG. 8C is a circuit configuration showing a part of the imaging apparatus 1000 of the first embodiment and a part of the specific accessory device;

FIG. 9 shows an example of a determination factor unit;

FIG. 10 shows an example of the determination factor unit;

FIG. 11 shows an example of the determination factor unit;

FIG. 12 shows an example of the determination factor unit; and

FIG. 13 is a block diagram showing another embodiment (an example).

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

1.1 Overall Structure

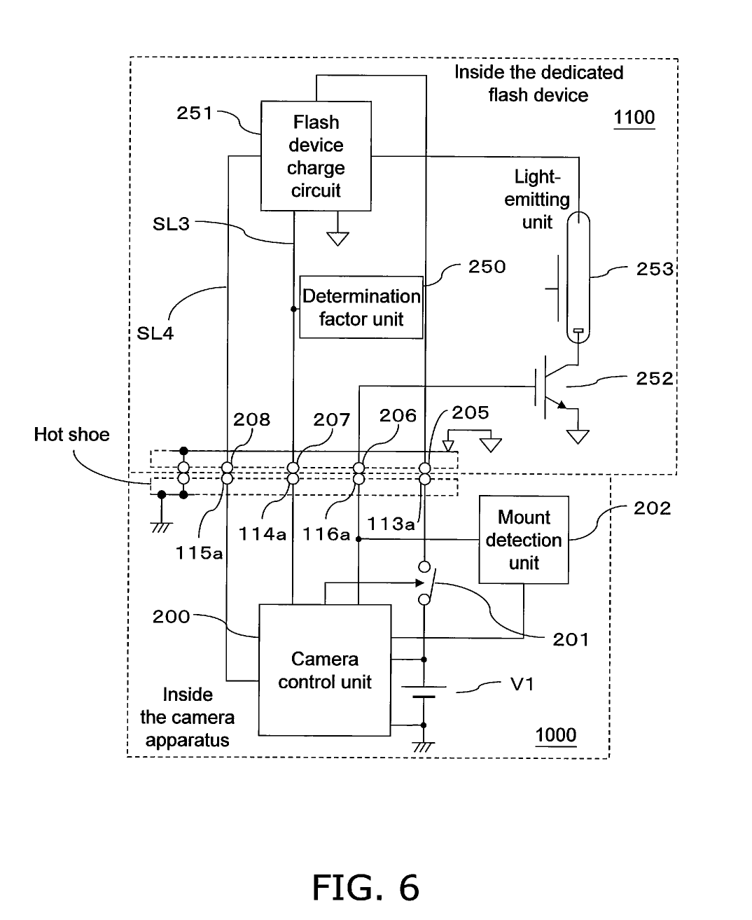

FIG. 6 shows a schematic structure of an imaging apparatus 1000 according to a first embodiment of the present technology and a dedicated flash device 1100, which functions as a specific accessory device.

As shown in FIG. 6, the imaging apparatus 1000 includes a camera control unit 200, which functions as a control unit, a mount detection unit 202, a hot shoe having shoe terminals 113a to 115a, a power supply voltage V1, and a power supply switch 201.

As shown in FIG. 6, the dedicated flash device 1100 includes hot-shoe-connection terminals 205 to 208, which are to be connected to the shoe terminals 113a to 115a of the camera control unit 200, a determination factor unit 250, a flash device charge circuit 251, a discharge switch 252, and a light-emitting unit 253.

The power supply switch 201, the power supply voltage V1, and the camera control unit 200 together function as a power supply unit.

1.2 Operation of the Imaging Apparatus

The operation of the imaging apparatus 1000 according to the first embodiment will now be described.

1.2.1 Operation 1: when the dedicated flash device 1100 (device without including an internal power supply) is connected

FIG. 6 shows an example of the present embodiment.

In the example shown in FIG. 6, the dedicated flash device 1100, which functions as a specific accessory device, does not include an internal power supply (a battery for example). The imaging apparatus (the camera apparatus) 1000 can directly perform the emission light adjustment and control charging of the dedicated flash device 1100.

The dedicated flash device 1100 is assumed to be a device that releases the electricity charged in its large-capacity capacitor when the light-emitting unit 253 formed by a xenon tube is excited. However, the dedicated flash device 1100 should not be limited to such a device. For example, a light-emitting unit included in a specific accessory device that is connected to the imaging apparatus 1000 via the hot shoe should not be limited to the xenon tube but can be, for example, a light emitting diode (LED).

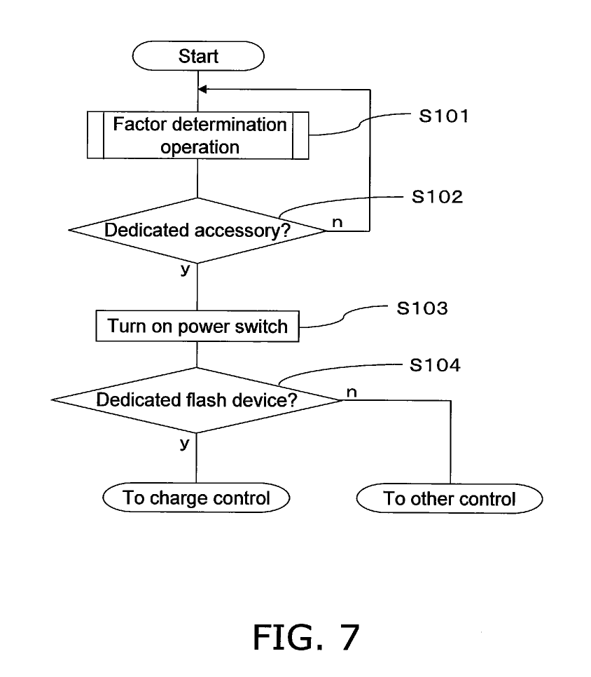

FIG. 7 is a flowchart schematically showing the operation of the imaging apparatus 1000.

The operation of the imaging apparatus 1000 will now be described with reference to the flowchart of FIG. 7.

In the imaging apparatus 1000, the mount detection unit 202 detects that an external device has been mounted on the imaging apparatus 1000. More specifically, a hot-shoe-connection terminal of the external device is pulled up to the power supply voltage via a resistor. The mount detection unit 202 reads the voltage value of the corresponding shoe terminal either directly or indirectly to detect that the external device has been mounted on the imaging apparatus 1000. In the example shown in FIG. 6, the hot-shoe-connection terminal 206 of the external device is pulled up to the power supply voltage via a resistor (the corresponding circuit is not specifically shown). In this case, the mount detection unit 202 directly or indirectly reads the voltage value of the corresponding shoe terminal 116a to detect that the external device has been mounted on the imaging apparatus 1000.

The imaging apparatus 1000 subsequently determines whether the external device connected to the imaging apparatus is a general-purpose external flash device or a specific accessory device.

In the example shown in FIG. 6, the dedicated flash device 1100 includes the determination factor unit 250, which transmits information indicating that the flash device 1100 is a specific accessory device to the imaging apparatus 1000. For example, the determination factor unit can be a high-precision resistance component.

The camera control unit 200 feeds a current limited to a specific amount to one shoe terminal 114a, and regularly reads the voltage value that is determined by the configuration of the circuit connected to the shoe terminal 114a in the imaging apparatus 1000 and the resistance component forming the determination factor unit 250 (for example, regularly reads the voltage value at the shoe terminal 114a directly or indirectly) (S101).

When determining that the read voltage value is a value determined by the resistance component of the determination factor unit 250 (yes in S102), the camera control unit 200 determines that the external device connected to the imaging apparatus 1000 is a specific accessory device, and turns on the power supply switch 201 (S103). This starts supplying power from the internal power supply V1 of the imaging apparatus (the camera apparatus) 1000 to the flash device charge circuit 251 included in the dedicated flash device 1100. For safety, the supplied power is controlled with limited current (not shown).

When the read voltage value (the voltage value at the terminal 114a) agrees with a predetermined voltage value set for the dedicated flash device 1100, the imaging apparatus 1000 determines that the connected external device is the dedicated flash device 1100 (yes in S104), and shifts to the control for charging the flash device (flash charge control). In this case, the signal lines connected to some shoe terminals (115a and 114a) are set (changed) to function under the flash charge control.

The signal line connected to the shoe terminal 114a is switched (set) to function as a line for reading a charge voltage signal (SL3), which is connected to the hot-shoe-connection terminal 207. The signal line connected to the hot-shoe-connection terminal 115a is set to function as a line for outputting charging pulses from the camera control unit 200 to the flash device 1100, or is set as a line (SL4) for feeding charging pulses of the dedicated flash device 1100 (when the determination result in S104 is yes).

The imaging apparatus 1000 can execute the flash charge control in the same manner as the flash charge control executed by a built-in flash imaging apparatus. More specifically, the camera control unit 200 transmits charge control pulses (SL4) to the flash device charge circuit 251 while monitoring (using the signal line SL3) the charge voltage of the main capacitor (not shown) for accumulating light emission energy included in the flash device charge circuit 251. The charge control is executed by pulse width modulation (PWM) control using voltage feedback, in which the flyback transformer raises the voltage.

The camera control unit 200 stops charging electricity to the main capacitor in the dedicated flash device 1100 when the charge voltage of the dedicated flash device 1100 reaches a specific value. The dedicated flash device 1100 then enters a state in which it can flash.

The camera control unit 200 can also operate the discharge switch 252 at a high speed in the emission light adjustment operation. The camera control unit 200 can thus reduce the flashing time up to the extremely short time possible with the emission light adjustment performed by a built-in flash imaging apparatus.

The use of a high-voltage device (e.g., a thyristor) at a synchronization terminal (a trigger terminal) of the hot shoe will now be described. In recent years, camera apparatuses of some types can be designed to drive only a flash device at their low-voltage trigger terminal, without being designed to perform high-voltage driving of an old flash device, although such old flash devices are still in use in the market. Low-voltage switch devices at a high speed are available at low prices. The use of such a low-voltage switch device enables direct adjustment of the emission light at a high speed. However, the flash device using such a low-voltage switch device would require only direct driving. Such flash drives that need to be driven directly lack versatility in the present market.

Many high-speed devices that withstand high voltages are available in the market. The use of such a high-speed high-voltage device would enable the high-speed operation with emission light adjustment capability. However, the high-speed high-voltage devices cannot be designed compact and also would require high cost, and thus are not for practical use.

The use of a high-voltage device (e.g., a thyristor) at a synchronization terminal (a trigger terminal) of the hot shoe would delay the timing of stop emitting light, and would disable the emission light to be adjusted so that the emission light emits only during the desired duration for emitting the light.

In this case, it is only required that the output of the high-voltage device and the direct output of the light emission signal be switched inside the camera control unit 200 (not shown).

1.2.2 Operation 2: when the dedicated flash device 1200 (device without an internal power supply) is connected

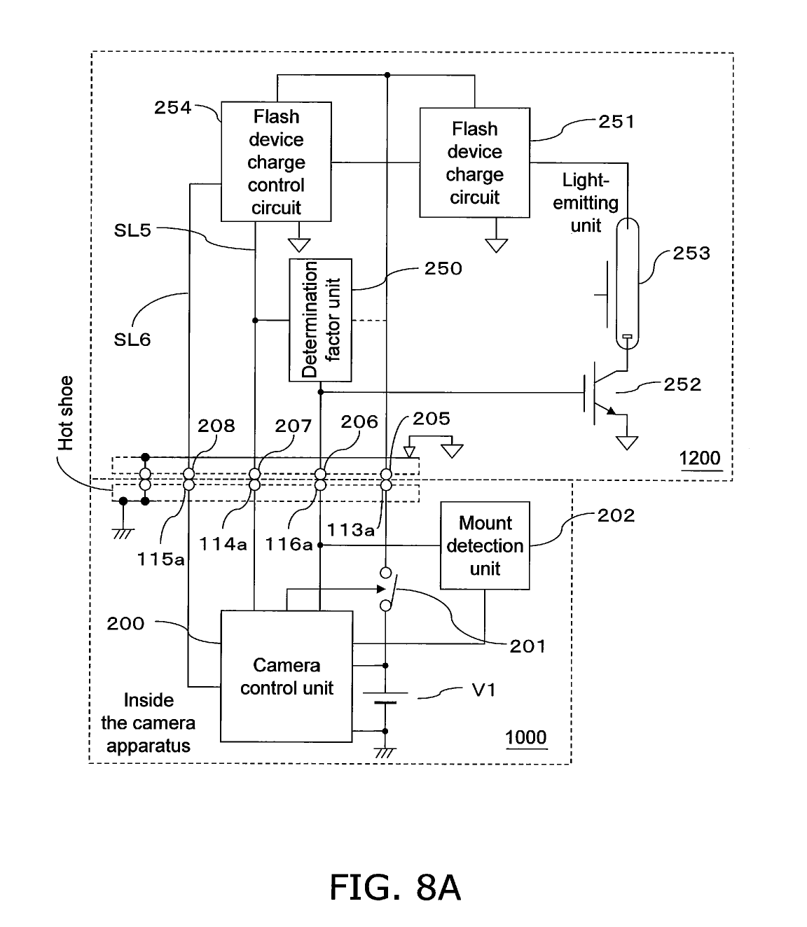

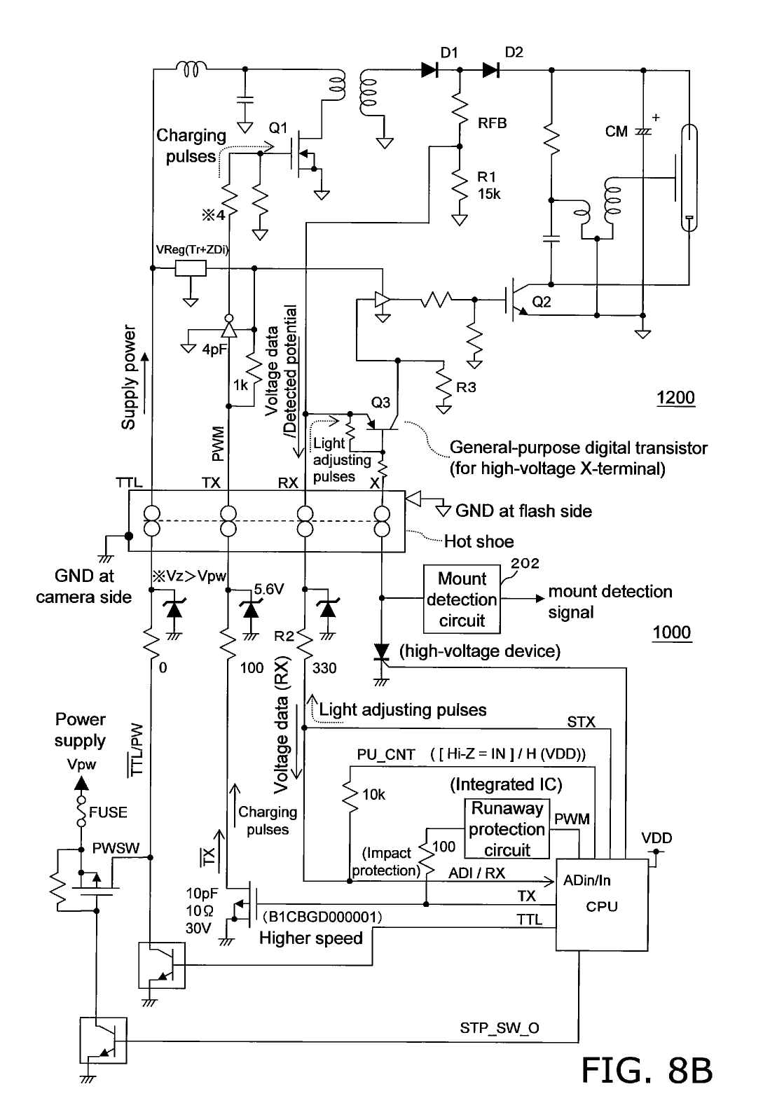

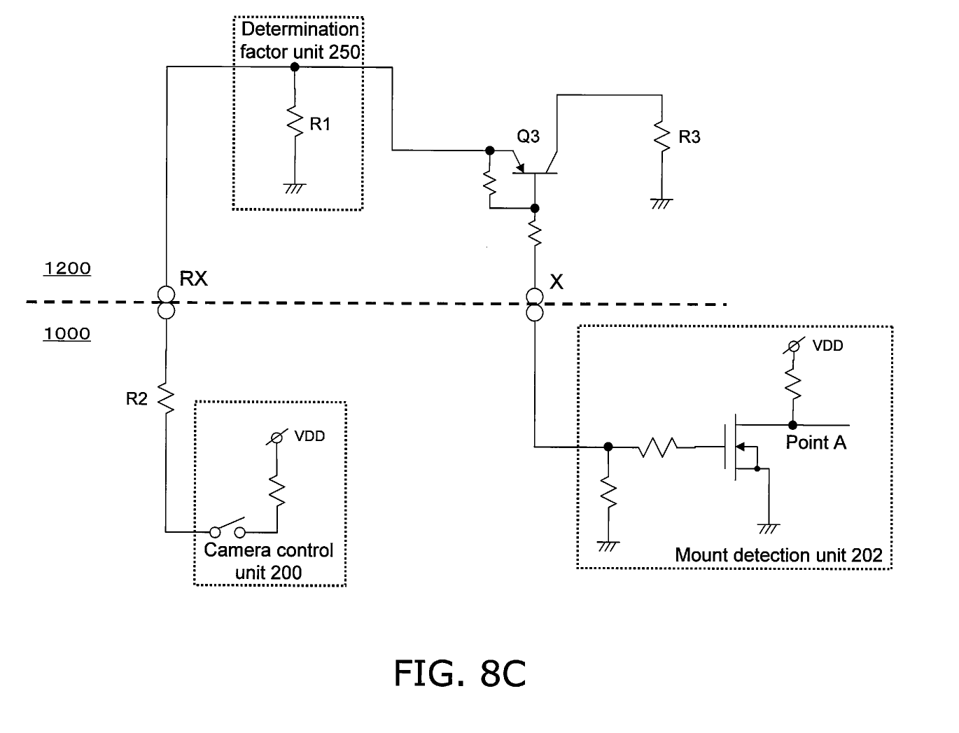

FIGS. 8A to 8C show another example of the present embodiment.

FIG. 8A shows the structure in which the flash device is controlled directly by the camera control unit 200 as in the example shown in FIG. 6, and the dedicated flash device 1200 internally includes the charge control circuit 251 unlike in the example shown in FIG. 6, and also the determination factor unit 250 is slightly more complicated.

The shoe terminal 114a of the imaging apparatus 1000 has been pulled up to the power supply voltage via a resistor to receive communication signals output from an open collector terminal of the general-purpose external flash device. The voltage to be pulled up and the pull-up resistor are highly precise. In this case, a divided voltage determined by the high-precision resistance component (the high-precision resistor) included the determination factor unit 250 and the pull-up resistor can be detected with a high precision. The high-precision resistor included in the determination factor unit 250 of the dedicated flash device 1200 is pulled down to the internal GND. In this structure, a divided voltage occurs when the dedicated flash device 1200 is mounted on the hot shoe, without supplying power to the dedicated flash device 1200.

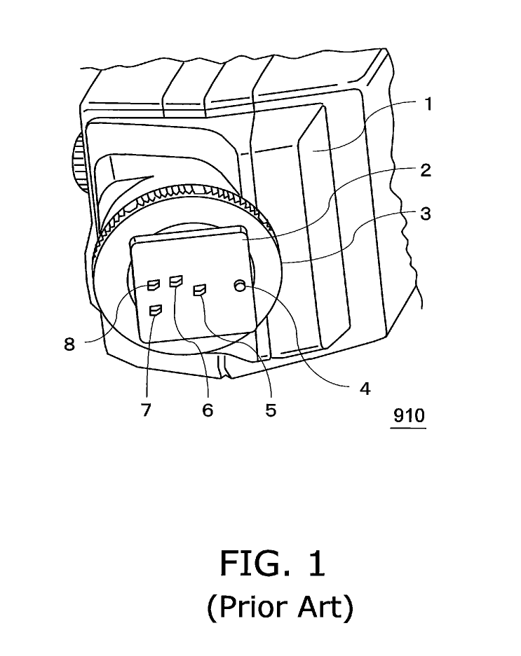

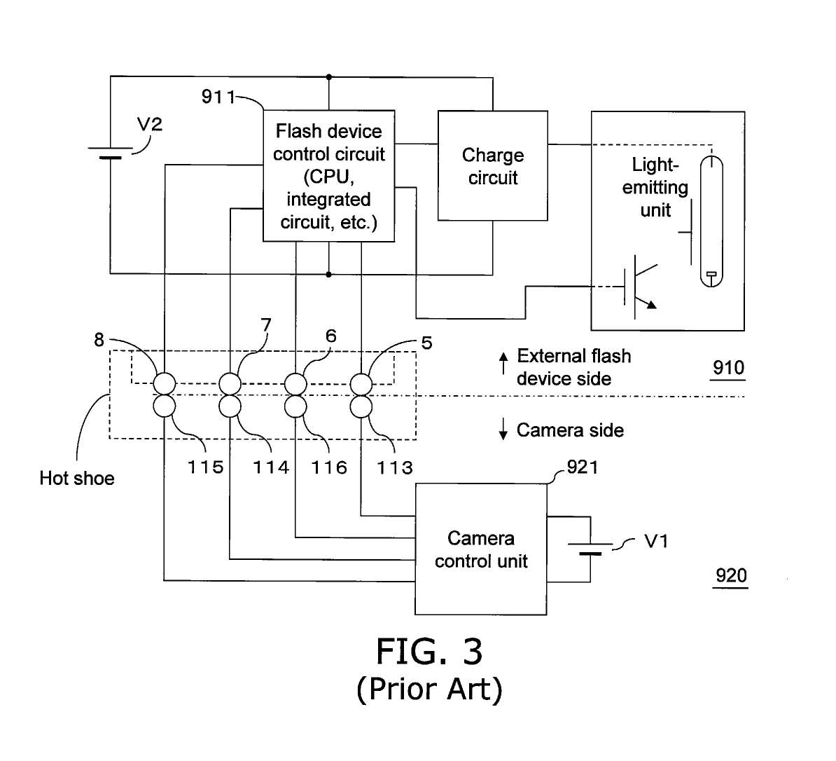

When the external flash device is mounted, the synchronization terminal 5 (refer to FIGS. 1 and 3) has been pulled up to the power supply voltage via the resistor in the general-purpose external flash device. In this case, the mount detection unit 202 detects a high (H) level signal. More specifically, when the synchronization terminal (refer to FIGS. 1 and 3) of the general-purpose external flash device is connected to the shoe terminal 116a of the imaging apparatus 1000, the synchronization terminal 5 (refer to FIGS. 1 and 3) is pulled up to the power supply voltage via the resistor in the general-purpose external flash device. In this case, the mount detection unit 202 detects that the external device has been mounted on the imaging apparatus 1000 by directly or indirectly detecting the voltage value of the shoe terminal 116a, which is determined by the resistor pulled up to the power supply voltage in the general-purpose external flash device and the circuit configuration of the mount detection unit.

The mount detection unit 202 can also detect the signal level at the input terminal of the direct control circuit when the control circuit included in the camera control unit 200 is a complementary metal oxide semiconductor (CMOS) circuit. In this case, the input current should be reduced significantly (the value of the input current should be reduced significantly) using a high-value resistor (a resistor with a resistance value of tens of mega-ohms). This would prevent breakage at the input terminal from occurring when an old-type flash device is mounted on the imaging apparatus 1000.

The determination factor unit 250 feeds back the dived voltage, whose voltage value is determined by the determination factor unit 250 and the voltage at the shoe terminal 114a pulled up to the power supply voltage, to the synchronization terminal 116a using a small amount of current. This can also cause the mount detection unit 202 arranged at the synchronization terminal 116a to detect the external device (to enter the on-state).

This processing will be described using one circuit example.

FIG. 8B is a circuit example corresponding to the example shown in FIG. 8A.

For ease of explanation, an RX-terminal shown in FIG. 8B corresponds to the shoe terminal 114a shown in FIG. 8A, an X-terminal shown in FIG. 8B corresponds to the shoe terminal 116a shown in FIG. 8A, and a resistor R1 shown in FIG. 8B corresponds to the resistance component included in the determination factor unit 250.

FIG. 8C shows an example of the circuit configuration including only a part of the circuit configuration shown in FIG. 8B associated with the determination as to whether the external device mounted on the imaging apparatus is a specific accessory device.

As shown in FIG. 8C, the camera control unit 200 (corresponding to a CPU in FIG. 8B) feeds a current (voltage) corresponding to a H level or a L level to the RX terminal via the resistor R2. As a result, the voltage at the X terminal or at point A shown in FIG. 8C changes in synchronization with the H or L level output from the camera control unit 200.

As a result, the imaging apparatus 1000 can determine that the external device mounted on the imaging apparatus is a specific accessory device, which is the dedicated flash device 1200 in the example shown in FIGS. 8A to 8C.

In this manner, the voltage at the hot-shoe-connection terminal 207 can be fed back to the synchronization terminal 116a. This enables verification of the logic operation using voltages.

In the logic operation verification, the signal level at the shoe terminal 114a is set freely to H or L after the divided voltage determined by the resistance component of the determination factor unit 250 is read, and then the voltage occurs at the shoe terminal 116a in synchronization with the signal level setting. The voltage occurring at the shoe terminal 116a is detected to perform verification.

The divided voltage determined by the resistance component alone would not be reliable because any failure may cause an unstable resistance value to appear between the shoe terminals. Such a failure may cause the imaging apparatus to perform an erroneous operation. In contrast, the verification through the logic operation increases the reliability of the determination performed by the imaging apparatus.

A broken line drawn from the determination factor unit 250 to the line connecting to the terminal 205, as shown in FIG. 8A, indicates that the determination factor unit 250 can be connected to any one of the hot-shoe-connection terminals. The example shown in FIG. 8A assumes that the determination factor unit 250 is connected to the terminals 206 and 207, but the present technology should not be limited to this configuration.

Determination Factor Unit

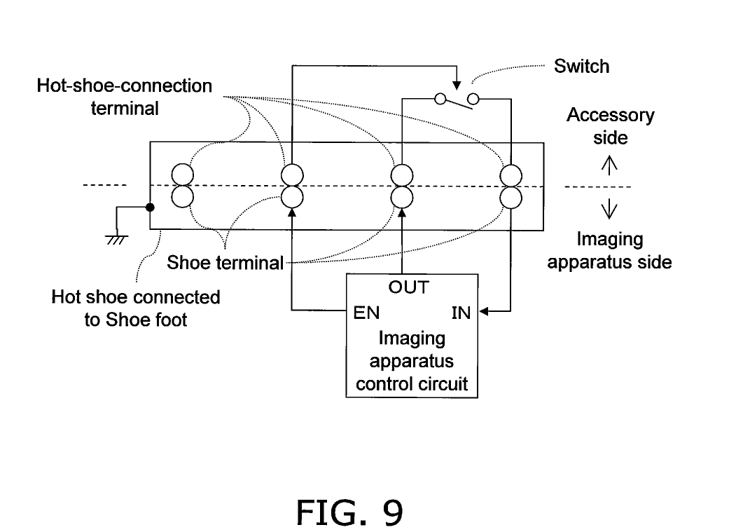

FIGS. 9 to 12 show examples of the determination factor unit.

A simpler version of the determination factor unit described above can use short-circuiting, which connects two of a plurality of hot-shoe-connection terminals or connects at least one of a plurality of hot-shoe-connection terminals to a power supply (with a certain polarity).

However, if this method of short-circuiting between two of the hot-shoe-connection terminals is simply employed, this method may erroneously detect short-circuiting for determination factor unit as short-circuiting due to failure.

Further, this method is applicable only to an accessory that does not need to use the hot-shoe-connection terminals that are to be short-circuited. This method is thus less safe, and lacks extensibility.

FIG. 9 shows a logic example in which a simple switch operation is used as the determination factor. In this example, three hot-shoe-connection terminals are used. One of the three terminals is used to control opening and closing a switch, and the remaining two terminals are used to read the open or closed state of the switch.

One side of the switch can be connected to ground or to a positive electrode. In this case, the two factors, that is, the opening and closing control and the open and closed state can be used by the determination factor unit. In this case, the imaging apparatus 1000 changes the potential (voltage) at one side of the switch, and detects that the potential (voltage) at the other side of the switch changes in synchronization with this change. Based on this, the imaging apparatus 1000 determines that the external device mounted on the imaging apparatus is a specific accessory device having the circuit configuration shown in FIG. 9. The switch can use a semiconductor to convert the direct current resistance component through V/R conversion.

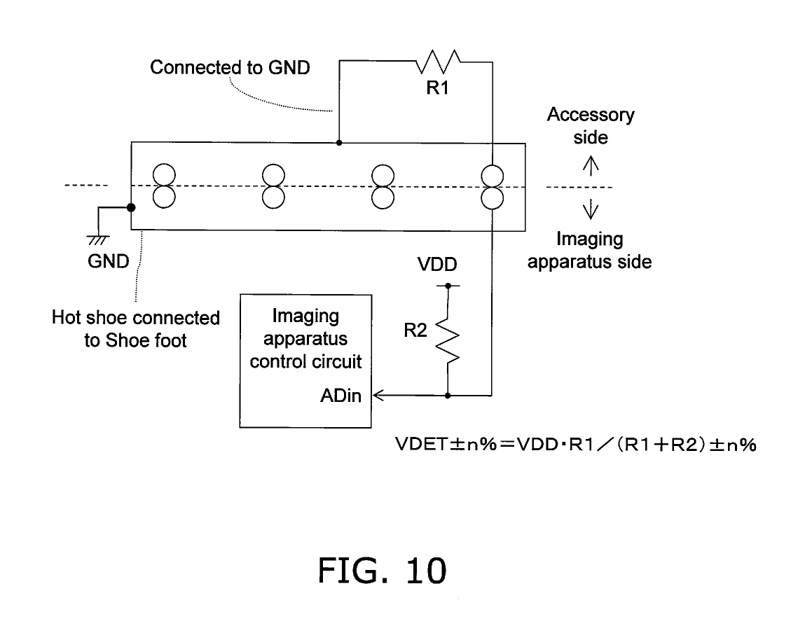

FIG. 10 shows an example in which a resistance component of a simple analogue factor is used as the determination factor. In this example, the determination process is performed through detecting a voltage occurring when a resistor having one terminal connected to ground is pulled up to a voltage source via a resistor.

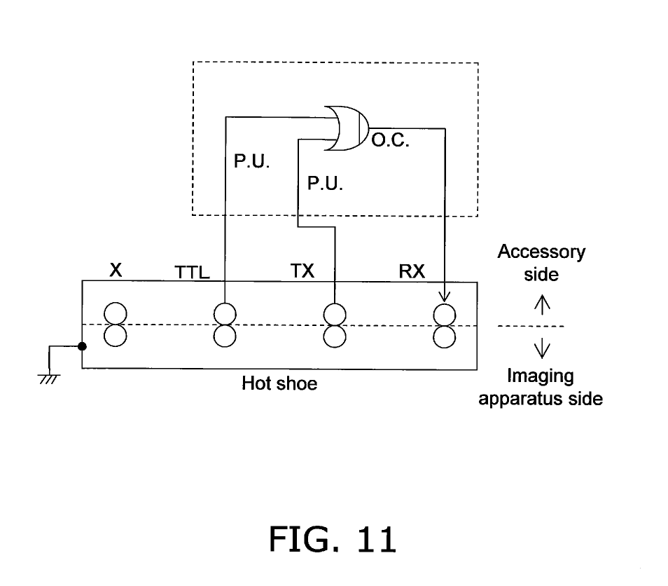

FIG. 11 shows an example in which a logic operation is used as the determination factor. The imaging apparatus 1000 changes the state of the two terminals. The state of the two terminals is output and returned to the imaging apparatus. Using this information, the imaging apparatus 1000 determines that the external device connected to the imaging apparatus is a specific accessory device having the circuit configuration shown in FIG. 11. In the example shown in FIG. 11, the OR output (wired OR output) of the TTL terminal and the TX terminal is an open collector. In this case, the RX terminal at the imaging apparatus side is pulled up to the internal power supply of the imaging apparatus 1000 via a resistor.

The imaging apparatus 1000 applies the voltage corresponding to the predetermined H level or L level to the TTL terminal and to the TX terminal. The imaging apparatus 1000 then determines whether an output corresponding to the logical circuit shown in FIG. 11 appears at the RX terminal. Based on the determination result, the imaging apparatus 1000 can determine whether the external device connected to the imaging apparatus is a specific accessory device having the circuit configuration shown in FIG. 11.

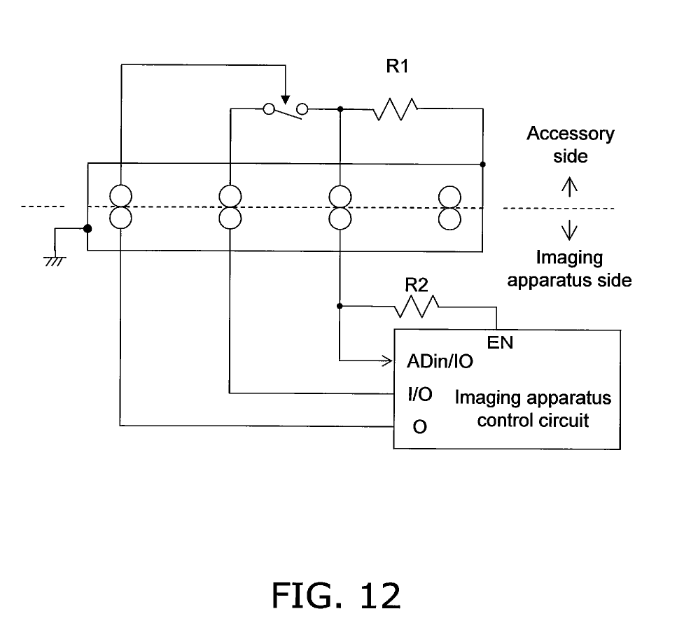

FIG. 12 shows the configuration combining the examples shown in FIGS. 9 and 10.

The method for detecting the external device and the type of the determination factor unit can be roughly categorized as

(1) digital communication using a complicated circuit,

(2) verification through a simple logic operation, and

(3) detection of a property of an analogue factor.

Although various other determination methods can be derived from these three methods, at least one of the above three methods (determination methods) can be used.

When digital communication is used for the determination, the circuit communicating with the general-purpose external flash device can be used. This method requires no switching unit for switching the communication function. However, this method requires the specific accessory device to include a processing circuit for generating the communication protocol, and thus requires the communication processing circuit included in the specific accessory device to be driven before the imaging apparatus determines whether the external device mounted on the apparatus is a specific accessory device. In this case, the specific accessory device is required to include a secondary battery, or to have a complicated structure providing preliminary power supply using a small amount of current. This consequently increases the cost.

Also, the determination unit for detecting the external device can be achieved wirelessly using, for example, photoelectric conversion or magnetic detection. However, this method requires a complicated and high-cost structure.

To mount a dedicated flash device that does not independently include a battery and a flash device control circuit on the imaging apparatus as a specific accessory device, the imaging apparatus is required to invalidate the circuit characteristic part for mounting an external flash device.

As described above, when the specific accessory device is connected to the imaging apparatus 1000 via the hot shoe, the imaging apparatus 1000 determines that the device mounted is a specific accessory device in a reliable manner using the determination factor unit. A storage unit such as a register or a read-only memory (not shown) prestores data necessary to detect the specific accessory device. The imaging apparatus can include, for example, a comparator for detecting that the external device is a specific accessory device using hardware, and can detect the specific accessory device using the comparator.

When determining that the external device mounted is not a specific accessory device, the imaging apparatus 1000 does not supply power to the external device, as with the conventional technology, and performs the same processing as the processing performed with the conventional technology.

As described above, the imaging apparatus 1000 according to the present embodiment supplies power to a specific accessory device using one of shoe terminals only when determining that the specific accessory device requiring power supply has been mounted, while enabling the shoe terminals to remain usable to transmit signals for controlling the general-purpose external flash device as in the conventional apparatus, and also enabling the hot shoe to maintain its versatility.

The imaging apparatus 1000 sets the shoe terminals, except the shoe terminal used to supply power, to achieve predetermined functions as required (allocates the communication functions to such shoe terminals) when detecting that a specific accessory device has been mounted.

More specifically, the imaging apparatus 1000 provides a power supply system that performs the operations (1) and (2) described below in a reliable and safe manner, using a hot shoe originally aimed to communicate between a general-purpose external flash device and an imaging apparatus when the general-purpose external flash device that executes charge control independently using its internal battery is mounted to the imaging apparatus. That is, the imaging apparatus performs, using the hot shoe, (1) supplying power only when a specific accessory device is mounted, and (2) prohibiting supply of power to a general-purpose external flash device that independently includes an internal power supply (a battery for example).

### Other Embodiments

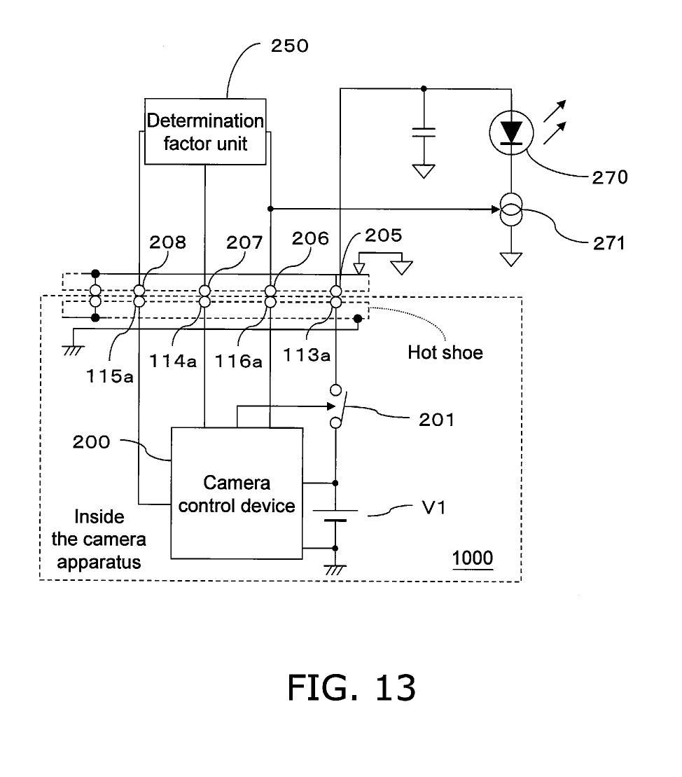

FIG. 13 shows another embodiment of the present technology.

FIG. 13 shows an example in which a dedicated movie light for movie recording is a specific accessory device. An imaging apparatus 1000 in this example uses an LED 270, which can be instantaneously driven using a large amount of current. When a determination factor unit 250 determines that the dedicated movie light is a specific device, the imaging apparatus supplies power (turns on a power supply switch 201), and enables control over a V/I (voltage/current) converter 271. The V/I converter can then light the LED 270 in pulses at a relatively high speed, although the speed at which the LED flashes is not as high as the speed at which a xenon tube would flash.

Each block of the imaging apparatus described in the above embodiments can be formed using a single chip with a semiconductor device, such as LSI, or some or all of the blocks of the imaging apparatus can be formed using a single chip.

Although LSI is used as the semiconductor device technology, the technology can be an IC (integrated circuit), a system LSI, a super LSI, or an ultra LSI depending on the degree of integration of the circuit.

The circuit integration technology employed should not be limited to LSI, but the circuit integration can be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, can be used.

Further, if any circuit integration technology that can replace LSI emerges as an advancement of the semiconductor technology or as a derivative of the semiconductor technology, the technology can be used to integrate the functional blocks. Biotechnology is potentially applicable.

All or part of the processes performed by the functional blocks described in the above embodiments can be implemented using programs. All or part of the processes performed by the functional blocks described in the above embodiments is implemented by a central processing unit (CPU) included in a computer. The programs for those processes are stored in a memory device such as a hard disk or a ROM, and are read into a ROM or a RAM and implemented.

The processes described in the above embodiments can be implemented using either hardware or software (which can be combined together with an operating system (OS), middleware, or a predetermined library), or can be implemented using both software and hardware. When the imaging apparatus of each of the above embodiments is implemented by hardware, the imaging apparatus requires timing adjustment for their processes. For ease of explanation, the timing adjustment associated with various signals required in an actual hardware design is not described in detail in the above embodiments.

The processes described in the above embodiments cannot be performed in the order specified in the above embodiments. The order in which the processes are performed can be changed without departing from the scope and the spirit of the invention.

The present technology can also include a computer program enabling a computer to implement the method described in the above embodiments and a computer readable recording medium on which such a program is recorded. The computer readable recording medium can be, for example, a flexible disk, a hard disk, a CD-ROM, an MO, a DVD, a DVD-ROM, a DVD-RAM, a Blu-ray disc, or a semiconductor memory.

The computer program should not be limited to a program recorded on the recording medium, but can be a program transmitted with an electric communication line, a radio or cable communication line, or a network such as the Internet.

The specific structures described in the above embodiments are mere examples of the present technology, and can be changed and modified variously without departing from the scope and the spirit of the invention.

### APPENDIX

Note that the present technology discussed herein above can be achieved as described below:

A first aspect of the present technology as described herein above is to provide an imaging apparatus with a hot shoe and a control unit.

The hot shoe has a plurality of terminals for establishing electrical connection to an external device.

The control unit communicates, when an external flash device is connected to the hot shoe, with the external flash device using at least one of the plurality of terminals, determines a type of the connected external flash device, and sets a function of each of the plurality of terminals of the hot shoe in accordance with the determined type of the external flash device.

When an external device is connected to the imaging apparatus via the hot shoe, this imaging apparatus communicates with the external flash device using at least one of the plurality of terminals, and determines the type of the connected external flash device. The imaging apparatus thus can set the function of each of the plurality of terminals of the hot shoe in a manner optimum for the connected external flash device. This enables the function of each of the plurality of terminals of the hot shoe to be set in a manner that the specific accessory device can achieve its function when the specific accessory device is mounted, while enabling the hot shoe to maintain its versatility.

For example, when the hot shoe terminals include an X terminal, a TX terminal, an RX terminal, and a TTL terminal and the external device connected to the imaging apparatus is a general-purpose external flash device, the X terminal is set as a trigger terminal, the TX terminal as a transmission terminal, the RX terminal as a reception terminal, and the TTL terminal as an external emission light adjustment terminal.

When the external device connected to the imaging apparatus is not a general-purpose external flash device (when the external device is a specific accessory device), the hot shoe terminals are set in a manner to achieve the function of the specific accessory device. For example, the X terminal can be set as a terminal for a trigger signal and emission light adjusting pulses, the TX terminal as a terminal for a charge signal and an identification start signal, the RX terminal as a terminal for an identification signal, and the TTL terminal as a power supply terminal.

A second aspect of the present technology is to provide the imaging apparatus according to the first aspect wherein one of the plurality of terminals is a trigger terminal.

The control unit (1) transmits, when determining that the external flash device is a specific flash device, information indicating a flash timing to the specific flash device using a terminal that is one of the plurality of terminals of the hot shoe excluding the trigger terminal, and (2) transmits, when determining that the external flash device is not a specific flash device, information indicating a flash timing to the external flash device using the trigger terminal that is one of the plurality of terminals of the hot shoe.

The trigger terminal is specifically a synchronizer contact (an X terminal, or a synchronization terminal) that is defined by, for example, Japanese Industrial Standards (JIS).

The specific accessory device is a device that can be mounted on the hot shoe of the imaging apparatus, and can specifically be an electric accessory that operates using power supplied from the imaging apparatus.

A third aspect of the present technology disclosed herein above is to provide an imaging apparatus that includes a hot shoe, a control unit, and a power supply unit.

The hot shoe has a plurality of terminals for establishing electrical connection to an external device.

The control unit communicates, when an external flash device is connected to the hot shoe, with the external flash device using at least one of the plurality of terminals, determines a type of the connected external flash device, and determines whether power is to be supplied to the external flash device via at least one of the plurality of terminals of the hot shoe in accordance with the determined type of the external flash device.

The power supply unit supplies power to the external flash device via at least one of the plurality of terminals of the hot shoe when the control unit determines that power is to be supplied to the external flash device.

This imaging apparatus can supply power to an external flash device only when the external flash device connected to the imaging apparatus requires power supply from the imaging apparatus, while enabling the hot shoe to maintain its versatility.

The present technology enables an imaging apparatus to (1) prohibit power supply from a power supply included in the imaging apparatus when an accessory device requiring no power supply, such as a general-purpose external flash device independently including an internal power supply, is mounted on a hot shoe of the imaging apparatus, and (2) supply power only to a specific accessory device designed to receive power from the imaging apparatus.

The specific accessory device can be a dedicated flash device. In this case, the present technology eliminates the need for a power supply battery to be installed in the dedicated flash device and/or eliminates the need for a flash device control unit to be installed in the dedicated flash device although the dedicated flash device is external to the imaging apparatus. The eliminated need for the power supply battery and the control unit reduces the size and the cost of the external flash device.

Also, the use of a general-purpose hot shoe eliminates the need for a new mounting mechanism or a new connection terminal to be installed in the imaging apparatus for mounting a specific accessory device, and simplifies the structure of the imaging apparatus and reduces the cost of the imaging apparatus.

### INDUSTRIAL APPLICABILITY

The present technology enables power to be supplied only to a target accessory requiring power supply mounted on a hot shoe, while enabling the hot shoe for mounting a flash device to maintain its existing functions, and further enabling the hot shoe to change its communication terminal function in accordance with the function of the target accessory. The present technology is applicable to an imaging apparatus including a hot shoe, such as a digital camera. Also, the present technology enables any other accessory devices that can be mounted on the hot shoe to be driven using an external device determination unit and a power supply unit newly arranged for the hot shoe. Such accessory devices that can be mounted on the hot shoe can be camera accessories including a movie light, a level meter, an autofocus assist lamp, and an external input microphone, or other accessories including an electric toy that can be used to grab attention of people in a group photo or attention of a child in a photo.

### REFERENCE SIGNS LIST

1000 imaging apparatus
200 camera control unit (control unit)
202 mount detection apparatus
250 determination factor unit
201 power supply switch
V1 power supply voltage
5, 6, 7, 8 hot-shoe-connection terminals
113, 114, 115, 116 shoe terminals

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Accordingly, these terms, as utilized to describe the present invention, should be interpreted relative to the imaging apparatus.

The term “detect” or “detection” as used herein to describe an operation or function carried out by a component, a section, a device or the like includes a component, a section, a device or the like that does not necessarily require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An imaging apparatus comprising:
a hot shoe having a plurality of terminals configured to establish an electrical connection with an external flash device; and
a control unit configured to communicate with the external flash device using at least one of the plurality of terminals when the external flash device is connected to the hot shoe, the control unit being further configured to determine the type of external flash device connected to the hot shoe and to cause each of the plurality of terminals to function in accordance with the type of external flash device connected to the hot shoe.

2. The imaging apparatus according to claim 1, wherein
one of the plurality of terminals is a trigger terminal, and the control unit is configured to determine whether the external flash device is a specific flash device,
if the control unit determines that the external flash device is a specific flash device, the control unit is configured to transmit information indicating a flash timing to the specific flash device using one of the plurality of terminals excluding the trigger terminal, and
if the control unit determines that the external flash device is not a specific flash device, the control unit is configured to transmit information indicating a flash timing to the external flash device using one of the plurality of terminals designated as the trigger terminal.

3. An imaging apparatus comprising:
a hot shoe having a plurality of terminals configured to establish an electrical connection with an external flash device;
a control unit configured to communicate with the external flash device via at least one of the plurality of terminals when the external flash device is connected to the hot shoe, the control unit being further configured to determine the type of external flash device connected to the hot shoe and whether power is to be supplied to the external flash device via at least one of the plurality of terminals based on the type of external flash device connected to the hot shoe; and
a power supply unit configured to supply power to the external flash device via at least one of the plurality of terminals when the control unit determines that power is to be supplied to the external flash device.
